(19) United States
(12) Patent Application Publication
(10) Pub. No.: US 2023/0049918 A1
(43) Pub. Date: Feb. 16, 2023

(54) CONTROL DEVICE, SYSTEM, CONTROL METHOD, AND STORAGE MEDIUM STORING PROGRAM

(71) Applicant: DENSO CORPORATION, Kariya-city (JP)

(72) Inventor: Masatake WADA, Kariya-city (JP)

(21) Appl. No.: 17/974,887

(22) Filed: Oct. 27, 2022

Related U.S. Application Data
(63) Continuation of application No. PCT/JP2021/007098, filed on Feb. 25, 2021.

(30) Foreign Application Priority Data
Apr. 30, 2020 (JP) 2020-080181

(51) Int. Cl. B60W 30/06; G08G 1/0968

(52) U.S. Cl. CPC B60W 30/06; G08G 1/0968

(57) ABSTRACT

A control device for an automated valet parking lot includes: a travel path determination unit determining a travel path to one of a plurality of parking sections defined in the parking lot; a travel path transmission unit transmitting the travel path to a vehicle having a function of estimating an own position; and an accuracy evaluation unit evaluating an accuracy of the own position estimated by the vehicle. The accuracy evaluation unit is further configured to: recognize a position of the vehicle in the automated valet parking lot based on information from a sensor disposed in the automated valet parking lot; and evaluate the accuracy of the own position by determining whether the recognized position of the vehicle exceeds a preset allowable range that is a range including the travel path with a predetermined margin.

### CROSS REFERENCE TO RELATED APPLICATIONS

This application is a continuation application of International Patent Application No. PCT/JP2021/007098 filed on Feb. 25, 2021, which designated the U.S. and claims the benefit of priority from Japanese Patent Application No. 2020-080181 filed on Apr. 30, 2020. The entire disclosure of the above application is incorporated herein by reference.

### TECHNICAL FIELD

The present disclosure relates to a control device, a system, a control method, and a non-transitory computer readable storage medium storing a program.

### BACKGROUND ART

There has been known a parking lot management device. A typical parking lot management device determines a travel path to an empty parking space in a parking lot. The parking lot management device guides a vehicle to the empty parking space by using an autonomous driving function.

### SUMMARY

A first aspect of the present disclosure is a control device for an automated valet parking lot. The control device includes: a travel path determination unit configured to determine a travel path to one of a plurality of parking sections defined in the parking lot; a travel path transmission unit configured to transmit the travel path to a vehicle having a function of estimating an own position and an automated valet parking function; and an accuracy evaluation unit configured to evaluate an accuracy of the own position estimated by the vehicle when the vehicle is traveling in the automated valet parking lot. The accuracy evaluation unit is further configured to: recognize a position of the vehicle in the automated valet parking lot based on information from a sensor disposed in the automated valet parking lot; and evaluate the accuracy of the own position by determining whether the recognized position of the vehicle exceeds a preset allowable range that is a range including the travel path with a predetermined margin.

### BRIEF DESCRIPTION OF DRAWINGS

FIG. 1 is an explanatory diagram illustrating a configuration of an automated valet parking lot.

FIG. 2 is a block diagram illustrating a configuration of a control system.

FIG. 3 is a block diagram illustrating a functional configuration of a control unit.

FIG. 4 is a sequence diagram illustrating entering processing executed by the control system and a vehicle.

FIG. 5 is a sequence diagram illustrating the entering processing executed by the control system and the vehicle.

FIG. 6 is a sequence diagram illustrating the entering processing executed by the control system and the vehicle.

FIG. 7 is a sequence diagram illustrating the entering processing executed by the control system and the vehicle.

FIG. 8 is a sequence diagram illustrating exiting processing executed by the control system and the vehicle.

FIG. 9 is a sequence diagram illustrating the exiting processing executed by the control system and the vehicle.

FIG. 10 is a flowchart illustrating accuracy-related processing of a first embodiment.

FIG. 11 is an explanatory diagram illustrating a method of evaluating the accuracy of an own position estimated by an evaluation target vehicle.

FIG. 12 is a flowchart illustrating accuracy-related processing of a second embodiment.

FIG. 13A is a drawing conceptually illustrating a deviation amount between the current position of the evaluation target vehicle specified based on camera information and the own position estimated by the evaluation target vehicle.

FIG. 13B is a drawing exemplifying a first threshold value and a second threshold value.

### DESCRIPTION OF EMBODIMENTS

To begin with, a relevant technology will be described first only for understanding the following embodiments.

In a parking lot, a vehicle guided by a parking lot management device performs autonomous driving along a travel path while repeatedly estimating an own position. As a result of the inventor's detailed examination, the following problems were found. Due to aging, accidents, dirt, and the like, the accuracy of an own position estimated by a vehicle may get worse. When the accuracy of the own position estimated by the vehicle gets worse, it becomes easy for the vehicle to deviate from the travel path during autonomous driving. In one aspect of the present disclosure, it is preferable to provide a control device and system capable of evaluating the accuracy of an own position estimated by a vehicle.

As described above, the first aspect of the present disclosure is a control device for an automated valet parking lot. The control device includes: a travel path determination unit configured to determine a travel path to one of a plurality of parking sections defined in the parking lot; a travel path transmission unit configured to transmit the travel path to a vehicle having a function of estimating an own position and an automated valet parking function; and an accuracy evaluation unit configured to evaluate an accuracy of the own position estimated by the vehicle when the vehicle is traveling in the automated valet parking lot. The accuracy evaluation unit is further configured to: recognize a position of the vehicle in the automated valet parking lot based on information from a sensor disposed in the automated valet parking lot; and evaluate the accuracy of the own position by determining whether the recognized position of the vehicle exceeds a preset allowable range that is a range including the travel path with a predetermined margin.

The control device according to the one aspect of the present disclosure can evaluate the accuracy of the own position estimated by the vehicle. When the accuracy of the own position estimated by the vehicle is low, for example, the control device, a user of the vehicle, or the like can take measures based on a result of evaluation performed by the control device.

A second aspect of the present disclosure is a system including: a control device for an automated valet parking lot; and a vehicle. The vehicle includes an own position estimation unit configured to estimate an own position using a first sensor mounted in the vehicle; and an automated valet parking execution unit configured to execute automated valet parking. The control device includes an accuracy evaluation unit configured to evaluate an accuracy of the own position estimated by the own position estimation unit when the vehicle is traveling in the automated valet parking lot. The accuracy evaluation unit is further configured to: recognize a position of the vehicle in the automated valet parking lot based on information from a second sensor disposed in the automated valet parking lot; and evaluate the accuracy of the own position by determining whether the recognized position of the vehicle exceeds a preset allowable range that is a range including the travel path with a predetermined margin.

In the system according to the second aspect of the present disclosure, the control device can evaluate the accuracy of an own position estimated by a vehicle. When the accuracy of the own position estimated by the vehicle is low, for example, the control device, a user of the vehicle, or the like can take measures based on a result of evaluation performed by the control device.

A third aspect of the present disclosure is a control device for an automated valet parking lot. The control device includes: a travel path determination unit configured to determine a travel path to one of a plurality of parking sections defined in the parking lot; a travel path transmission unit configured to transmit the travel path to a vehicle having a function of estimating an own position and an automated valet parking function; an accuracy evaluation unit configured to evaluate an accuracy of the own position estimated by the vehicle when the vehicle is traveling in the automated valet parking lot; a proximity determination unit that is configured to determine, if the accuracy of the own position evaluated by the accuracy evaluation unit is lower than a preset reference, whether there is a proximate point at which a future travel path of the vehicle and a travel path of another vehicle having the automated valet parking function are close to each other; and a travel path change unit that is configured to change the travel path of the other vehicle having the automated valet parking function such that the proximate point does not exist.

The control device according to the third aspect of the present disclosure can evaluate the accuracy of an own position estimated by a vehicle. When the accuracy of the own position estimated by the vehicle is low, for example, the control device, a user of the vehicle, or the like can take measures based on a result of evaluation performed by the control device.

A fourth aspect of the present disclosure is a control method for an automated valet parking lot. The control method includes: determining a travel path to one of a plurality of parking sections; transmitting the travel path to a vehicle having a function of estimating an own position and an automated valet parking function; and evaluating an accuracy of the own position estimated by the vehicle when the vehicle is traveling in the automated valet parking lot. The method further includes: recognizing a position of the vehicle in the automated valet parking lot based on information from a sensor disposed in the automated valet parking lot; and evaluating the accuracy of the own position by determining whether the recognized position of the vehicle exceeds a preset allowable range that is a range including the travel path with a predetermined margin.

In the control method according to the fourth aspect of the present disclosure, the accuracy of an own position estimated by a vehicle can be evaluated. When the accuracy of the own position estimated by the vehicle is low, for example, the control device, a user of the vehicle, or the like can take measures based on an evaluation result.

Exemplary embodiments of the present disclosure will be described with reference to the drawings.

### First Embodiment

1. Configuration of Automated Valet Parking Lot 1

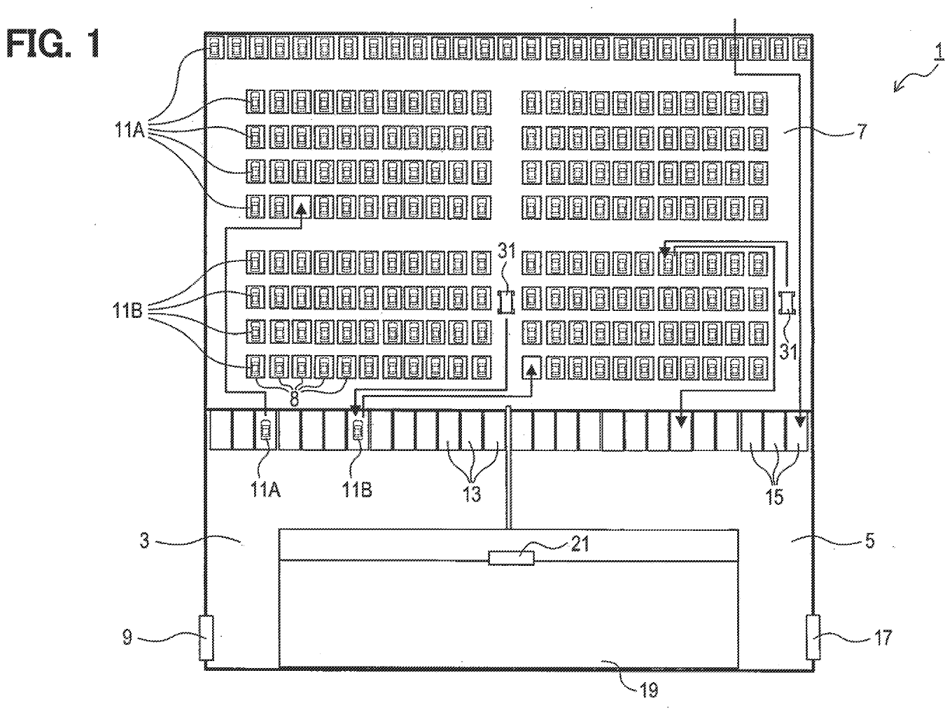

A configuration of the automated valet parking lot 1 will be described with reference to FIG. 1. The automated valet parking lot 1 includes an entering space 3, an exiting space 5, and a parking space 7. The parking space 7 is a space that includes a plurality of parking sections 8. Each of the parking sections 8 is a frame for parking one vehicle 11.

The entering space 3 is adjacent to the exiting space 5 and the parking space 7. The entering space 3 includes an entrance 9. The vehicle 11 to be parked from the outside of the automated valet parking lot 1 passes through the entrance 9 and enters the entering space 3. As the vehicle 11, there are a vehicle 11A with an AVP function and a vehicle 11B without the AVP function. The AVP function is an automated valet parking function. The vehicle 11A with the AVP function includes an AVP execution unit, and the AVP function is realized by the AVP execution unit.

The vehicle 11A with the AVP function has a function of estimating an own position. The vehicle 11A with the AVP function includes an own position estimation unit, and estimates an own position by using the own position estimation unit. The own position is a position of the vehicle 11A with the AVP function estimated by the vehicle 11A with the AVP function. The own position is a position in a coordinate system fixed to the earth. The own position may be a position in a coordinate system fixed to the automated valet parking lot 1. Information representing the own position will be hereinafter referred to as position information. A method of estimating the own position is as follows.

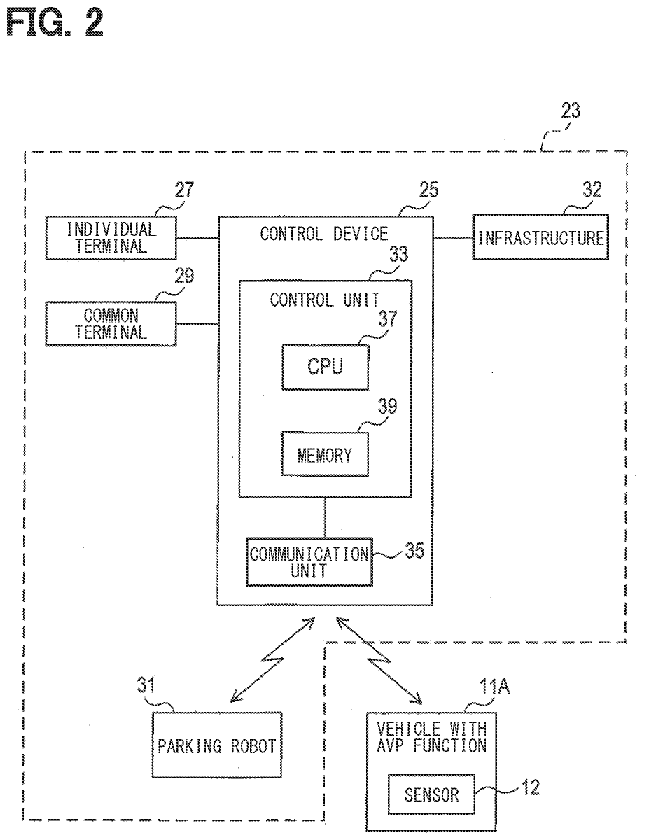

As illustrated in FIG. 2, the vehicle 11A with the AVP function includes a sensor 12. The sensor 12 is a camera. While the vehicle 11A with the AVP function is traveling in the automated valet parking lot 1, a range including a marker provided in the automated valet parking lot 1 is imaged by using the sensor 12 and an image is generated. The vehicle 11A with the AVP function estimates a relative position of the vehicle 11A with the AVP function with respect to the marker based on a relative position of the marker in the image.

The marker is displayed on, for example, a road surface or a wall surface in the automated valet parking lot 1. The marker is disposed, for example, on a display plate suspended from a ceiling of the automated valet parking lot 1. The marker is, for example, at a position where an image is captured by the sensor 12 when the vehicle 11A with the AVP function enters the entering space 3. The marker is, for example, at a position at which an image is captured by the sensor 12 when the vehicle 11A with the AVP function is traveling from the entering space 3 toward the parking space 7. The marker is, for example, at a position at which an image is captured by the sensor 12 when the vehicle 11A with the AVP function is traveling from the entrance 9 toward the entering space 3. The sensor 12 images a predetermined number or more of markers when the positions of the sensors 12 are the same. The predetermined number is, for example, three or more. The vehicle 11A with the AVP function estimates the own position of the vehicle 11A with the AVP function based on the positions of a predetermined number or more of markers.

The vehicle 11A with the AVP function reads an absolute position of the marker from map information of the automated valet parking lot 1. The absolute position is, for example, a position in a coordinate system fixed to the earth. The absolute position is, for example, a position in a coordinate system fixed to the automated valet parking lot 1. The vehicle 11A with the AVP function estimates the own position of the vehicle 11A with the AVP function from a relative position of the vehicle 11A with the AVP function with respect to the marker and the absolute position of the marker. For example, the map information includes position coordinates of each marker placed in a grid pattern. The vehicle 11A with the AVP function extracts position coordinates corresponding to a marker recognized by the sensor 12 from the map information and estimates an own position.

The vehicle 11A with the AVP function receives, for example, the map information of the automated valet parking lot 1 from the control device 25 after performing communication connection to the control device 25 when entering the automated valet parking lot 1. Alternatively, the vehicle 11A with the AVP function downloads and stores the map information of the automated valet parking lot 1 before entering the automated valet parking lot 1.

The entering space 3 includes multiple vehicle entering sections 13. The multiple vehicle entering sections 13 are arranged on the side of the parking space 7 in the entering space 3. Each vehicle entering section 13 has a size capable of accommodating one vehicle 11. The vehicle 11 that has entered the entering space 3 from the entrance 9 can enter any of the vehicle entering sections 13 and stop. The vehicle 11 in the vehicle entering section 13 may enter the parking space 7 by being transported by a parking robot 31 that will be described later or by using the AVP function.

The exiting space 5 includes multiple vehicle exiting sections 15. The multiple vehicle exiting sections 15 are arranged on the side of the parking space 7 in the exiting space 5. Each vehicle exiting section 15 has a size capable of accommodating one vehicle 11.

The vehicle 11 that has been unloaded from the parking space 7 enters one of the vehicle exiting sections 15. The exiting space 5 includes an exit 17. The vehicle 11 in the vehicle exiting section 15 can pass through the exit 17 and proceed to the outside of the automated valet parking lot 1. The parking space 7 is a space in which multiple vehicles 11 can be parked.

The entering space 3 and the exiting space 5 are adjacent to a facility 19. The facility 19 is, for example, a store, an office, a house, or a station. A gateway 21 of the facility 19 and the entering space 3 are connected via, for example, a pedestrian-only area. The gateway 21 and the exiting space 5 are connected via, for example, a pedestrian-only area.

2. Configuration of Control System 23

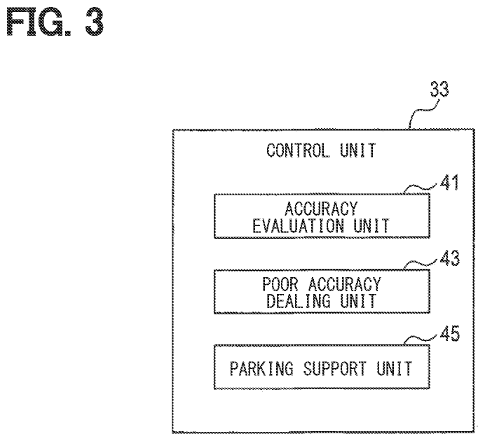

A configuration of the control system 23 will be described with reference to FIGS. 2 and 3. The control system 23 is used for the automated valet parking lot 1. As illustrated in FIG. 2, the control system 23 includes a control device 25, multiple individual terminals 27, a common terminal 29, a parking robot 31, and an infrastructure 32.

The control device 25 includes a control unit 33 and a communication unit 35. The control unit 33 includes a microcomputer having a CPU 37 and, for example, a semiconductor memory (hereinafter, referred to as a memory 39) such as a RAM or a ROM.

Each function of the control unit 33 is realized by the CPU 37 executing a program stored in a non-transitory computer readable tangible storage medium. In this example, the memory 39 corresponds to a non-transitory computer readable tangible storage medium in which a program is stored. The program is executed, and thus a method corresponding to the program is executed. The control unit 33 may include one microcomputer or multiple microcomputers.

As illustrated in FIG. 3, the control unit 33 includes an accuracy evaluation unit 41, a poor accuracy dealing unit 43, and a parking support unit 45. In the first embodiment, the poor accuracy dealing unit 43 corresponds to a travel path determination unit, a travel path transmission unit, a stop instruction unit, a proximity determination unit, a travel path change unit, and a notification unit.

The accuracy evaluation unit 41 evaluates the accuracy of an own position estimated by the parking robot 31 and the vehicle 11A with the AVP function while the vehicle 11A with the AVP function travels in the automated valet parking lot 1.

When the accuracy evaluated by the accuracy evaluation unit 41 is lower than a preset reference (i.e., a predetermined threshold), the poor accuracy dealing unit 43 instructs the vehicle 11A with the AVP function to stop.

When the accuracy evaluated by the accuracy evaluation unit 41 is lower than the preset reference, the poor accuracy dealing unit 43 determines whether there is a proximate point at which a future travel path of one vehicle 11A with the AVP function and a travel path of another vehicle 11A with the AVP function are close to each other.

When a determination is made that there is the proximate point where the travel paths are close, the poor accuracy dealing unit 43 changes the travel path for the other vehicle 11A with the AVP function such that the proximate point where the travel paths are close does not exist.

When the accuracy evaluated by the accuracy evaluation unit 41 is lower than the preset reference, the poor accuracy dealing unit 43 instructs the vehicle 11A with the AVP function or a terminal mounted on the vehicle 11A with the AVP function to notify a user.

The parking support unit 45 supports entering and exiting of the vehicle 11 as will be described later. The communication unit 35 can perform wireless communication with the parking robot 31 and the vehicle 11A with the AVP function.

Each of the multiple individual terminals 27 is associated with one vehicle entering section 13. Each individual terminal 27 is provided near the corresponding vehicle entering section 13. The individual terminal 27 accepts the user's operation. Examples of the user's operation include an entering request operation and input of user's identification information. The individual terminal 27 displays information to the user.

The common terminal 29 is provided in the exiting space 5. The common terminal 29 accepts user's operations. Examples of the user's operations include an exiting request operation and input of user's identification information. The common terminal 29 displays information to the user. The functions of the individual terminal 27 and the common terminal 29 may be realized by a mobile communication terminal owned by the user of the vehicle 11. Examples of the mobile communication terminal include smartphones.

The parking robot 31 has the following functions. The parking robot 31 can perform wireless communication with the control device 25. The parking robot 31 can receive a travel path from the control device 25. The parking robot 31 has map information of the automated valet parking lot 1.

The parking robot 31 has a function of estimating an own position, similar to the vehicle 11A with the AVP function. The own position of the parking robot 31 is a position of the parking robot 31. The parking robot 31 can create position information representing the estimated own position. The parking robot 31 can travel along the travel path by using the map information, the position information, and the travel path.

The parking robot 31 can lift up the vehicle 11. The parking robot 31 can travel along the travel path in a state in which the vehicle 11 is lifted up. The fact that the parking robot 31 travels in a state in which the vehicle 11 is lifted up corresponds to the parking robot 31 transporting the vehicle 11. The parking robot 31 can lower the lifted vehicle 11 onto the road surface.

The parking robot 31 can transmit the position information to the control device 25. The parking robot 31 can receive an instruction from the control device 25 and perform an operation corresponding to the instruction. Instructions include, for example, stop, start, and reroute. The parking robot 31 corresponds to a vehicle having an own position estimation function and an AVP function.

The infrastructure 32 includes multiple sensors for detecting states in respective parts of the automated valet parking lot 1. Examples of the sensors include cameras and LIDARs. Some of the cameras capture images of a license plate of the vehicle 11 in the vehicle entering section 13. A camera 32A that is any of the cameras images a passage 47 in the parking space 7 from above. The passage 47 is a portion of the parking space 7 in which the vehicle 11 and the parking robot 31 travel. Alternatively, the infrastructure 32 includes a LIDAR instead of the camera 32A. A detection range of the LIDAR includes the passage 47. The infrastructure 32 includes a device for guiding the vehicle 11. Examples of the guiding device include a display device that displays a traveling direction of the vehicle 11. The control device 25 and the vehicle 11A with the AVP function form the system of the present disclosure.

3. Entering Processing Executed by Control System 23 and Vehicle 11

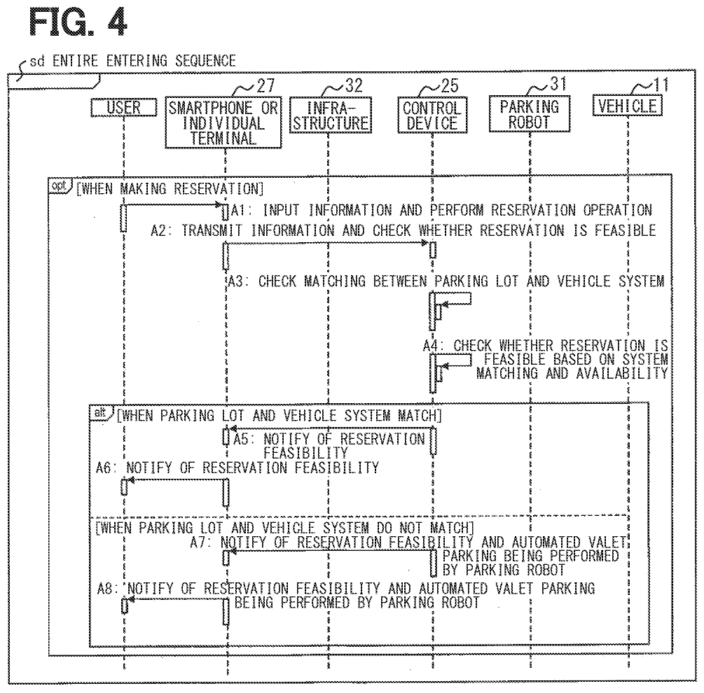

The entering processing executed by the control system 23 and the vehicle 11 will be described with reference to FIGS. 4 to 7.

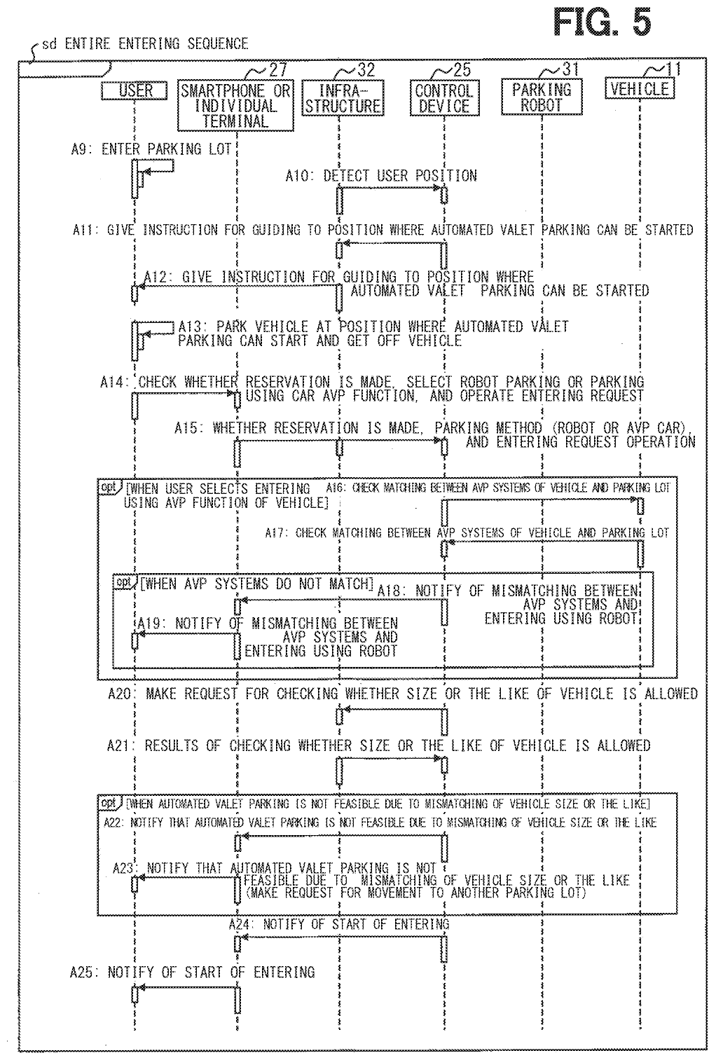

When a user makes a reservation for entering, processes A1 to A8 illustrated in FIG. 4 are performed. When the user does not make a reservation for entering, the processes A1 to A8 are not performed, and processes after A9 illustrated in FIG. 5 are performed.

In A1, the user inputs information into a smartphone and performs a reservation operation for entering. The smartphone is a terminal carried by the user. The information includes, for example, identification information of the vehicle 11, identification information of the user, the scheduled entering time, and the type of the AVP system installed in the vehicle 11.

In A2, the smartphone transmits the information input in A1 to the control device 25 and inquires whether the reservation is feasible.

In A3, the control device 25 checks matching between the parking lot and the vehicle 11 based on the information received in A2. Matching between the parking lot and the vehicle 11 means that the AVP system included in the vehicle 11 and the control system 23 match and the AVP function of the vehicle 11 can be used.

In A4, the control device 25 acquires the availability of the parking space 7, and checks whether a reservation for entering is feasible based on the acquired availability.

The processes in A5 and A6 are performed only when the control device 25 determines that the parking lot and the vehicle 11 match in A3. In A5, the control device 25 notifies the smartphone whether the reservation is feasible.

In A6, the smartphone notifies the user whether the reservation is feasible.

The processes in A7 and A8 are performed only when the control device 25 determines that the parking lot and the vehicle 11 do not match in A3. In A7, the control device 25 notifies the smartphone whether the reservation is feasible. The control device 25 notifies the smartphone that a parking method is robot parking. Robot parking is automated valet parking using the parking robot 31.

In A8, the smartphone notifies the user whether the reservation is feasible. The smartphone notifies the user that a parking method is robot parking.

In A9, the user enters the automated valet parking lot 1. In this case, the user is in the vehicle 11.

In A10, the infrastructure 32 detects positions of the user and the vehicle 11. The infrastructure 32 notifies the control device 25 of the positions of the user and the vehicle 11.

In A11, the control device 25 instructs the infrastructure 32 to guide the user and the vehicle 11 to a position where automated valet parking is feasible. The position where automated valet parking is feasible is one of the vehicle entering sections 13.

In A12, the infrastructure 32 guides the user and the vehicle 11 to a position where automated valet parking is feasible. For example, the control device 25 performs display to the user in the vehicle 11 by using the display device. Details of the display include, for example, a vehicle section number of the vehicle entering section 13 in which the vehicle 11 is to enter and an arrow indicating a direction in which the vehicle 11 is to advance.

In A13, the user parks the vehicle 11 at a position where automated valet parking is feasible and gets off the vehicle 11.

In A14, the user inputs information to the individual terminal 27. The information includes information regarding whether a reservation is made, a reservation number if a reservation is made, a parking method, an entering request, and the license plate of the vehicle 11. The parking method is either robot parking or parking using the AVP function. The user may input the information into the smartphone.

In A15, the individual terminal 27 transmits the information input in A14 to the control device 25. The smartphone may transmit the information input in A14 to the control device 25.

When the user selects parking using the AVP function, the processes in A16 to A19 are performed. When the user selects robot parking, the processes in A16 to A19 are not performed.

In A16, the control device 25 requests the vehicle 11 to check matching between the parking lot and the vehicle 11.

In A17, the vehicle 11 transmits an answer to the control device 25. Details of the answer are either an answer that the parking lot and the vehicle 11 match or an answer that the parking lot and the vehicle 11 do not match. When the answer is that the parking lot and the vehicle 11 do not match, the processes in A18 and A19 are performed. When the answer is that the parking lot and the vehicle 11 match, the processes in A18 and A19 are not performed.

In A18, the control device 25 notifies the individual terminal 27 that the parking lot and the vehicle 11 do not match and that the parking method is robot parking. The control device 25 may notify the smartphone.

In A19, the individual terminal 27 notifies the user that the parking lot and the vehicle 11 do not match and that the parking method is robot parking. The smartphone may notify the user.

In A20, the control device 25 requests the infrastructure 32 to check whether a size or the like of the vehicle 11 is allowed. The term “allowed” means that automated valet parking can be performed in automated valet parking lot 1.

In A21, the infrastructure 32 checks whether the size or the like of the vehicle 11 is allowed, and transmits a check result to the control device 25.

When the details of the answer in A21 are that the size or the like of the vehicle 11 is not allowed, the processes in A22 and A23 are performed, and the present process is finished. When details of the answer in A21 are that the size or the like of the vehicle 11 is allowed, the processes in A22 and A23 are not performed, and the processes in and after A24 are continuously performed.

In A22, the control device 25 notifies the individual terminal 27 that automated valet parking is not feasible because the size or the like of the vehicle 11 is not matched. The control device 25 may notify the smartphone.

In A23, the individual terminal 27 notifies the user that automated valet parking is not feasible because the size or the like of the vehicle 11 is not matched. The individual terminal 27 requests the user to move to another parking lot. The smartphone may notify and request the user.

In A24, the control device 25 notifies the individual terminal 27 of the start of entering. The control device 25 may notify the smartphone.

In A25, the individual terminal 27 notifies the user of the start of entering. The smartphone may notify the user of the start of entering.

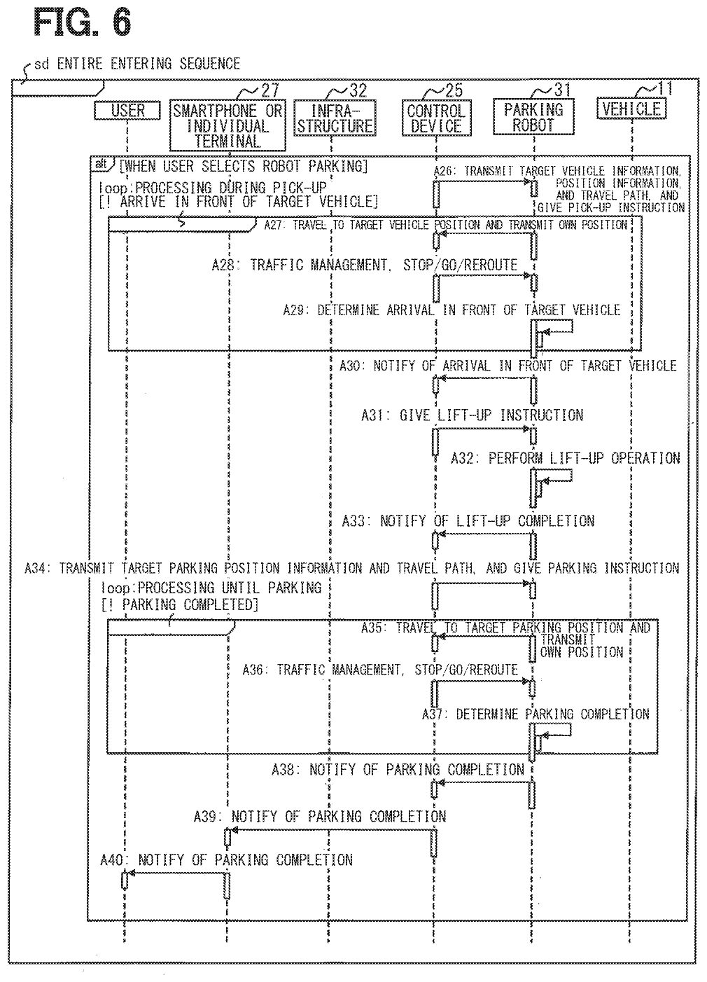

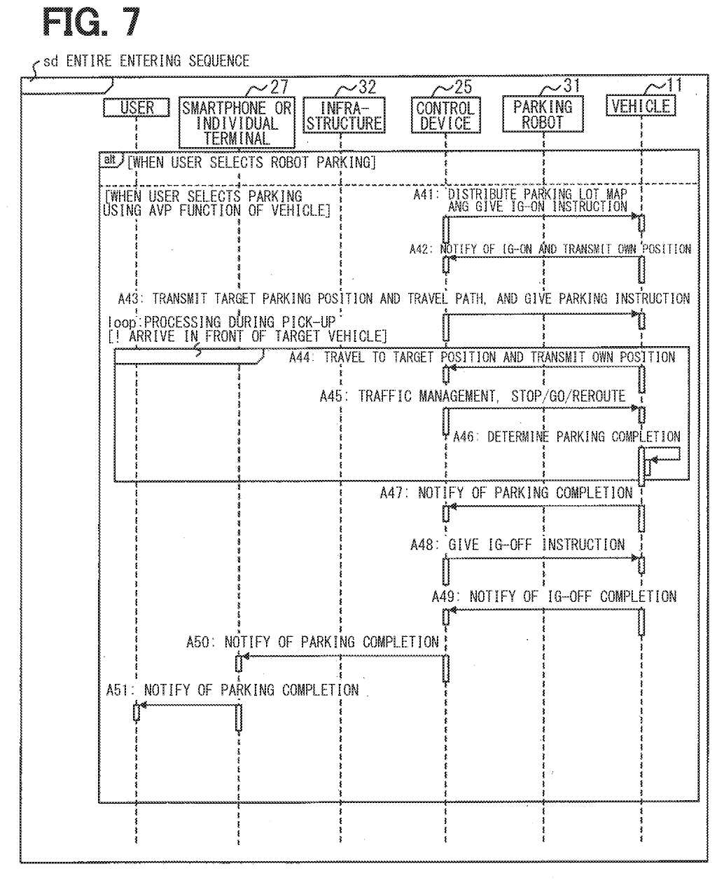

When the user selects robot parking, or when the robot parking is notified in A19, the processes A26 to A40 illustrated in FIG. 6 are performed. When the user selects parking using the AVP function and the robot parking is not reported in A19, the processes in A41 to A51 illustrated in FIG. 7 are performed.

In A26, the control device 25 transmits target vehicle information, position information, a travel path, and a pick-up instruction to the parking robot 31. The target vehicle information is information regarding a target vehicle. The target vehicle is the vehicle 11 that is about to be parked. The position information is position information indicating the current position of the target vehicle. The travel path is a travel path from the current position of the parking robot 31 to the current position of the target vehicle. The pick-up instruction is an instruction for picking up the target vehicle.

The processes in A27 to A29 are repeatedly performed until the parking robot 31 arrives in front of the target vehicle. In A27, the parking robot 31 travels toward the target vehicle position and transmits the current position of the parking robot 31 to the control device 25.

In A28, the control device 25 manages traffic based on the current position of the parking robot 31 received in A27. The control device 25 transmits instructions for stopping, starting, and rerouting to the parking robot 31 as necessary. The parking robot 31 stops, starts, and reroutes in response to the instructions.

In A29, the parking robot 31 determines whether the parking robot 31 has arrived in front of the target vehicle. When the parking robot 31 has not yet arrived in front of the target vehicle, the present process returns to A27. When the parking robot 31 has arrived in front of the target vehicle, the processes in A27 to A29 are finished, and the present process proceeds to A30.

In A30, the parking robot 31 notifies the control device 25 that the parking robot 31 has arrived in front of the target vehicle.

In A31, the control device 25 instructs the parking robot 31 to lift up the target vehicle.

In A32, the parking robot 31 lifts up the target vehicle. When the lift-up is completed, the present process proceeds to A33.

In A33, the parking robot 31 notifies the control device 25 of the completion of lift-up.

In A34, the control device 25 transmits target parking position information, a travel path, and a parking instruction to the parking robot 31. The target parking position information is information indicating a target parking position. The target parking position is a parking section 8 for parking the vehicle 11 from now on. The travel path is a travel path from the current position of the parking robot 31 to the target parking position. The parking instruction is an instruction for parking the target vehicle at the target parking position. The travel path is determined by the control device 25.

The processes in A35 to A37 are repeatedly performed until the parking robot 31 arrives at the target parking position. In A35, the parking robot 31 travels toward the target parking position and transmits the current position of the parking robot 31 to the control device 25.

In A36, the control device 25 manages traffic based on the position of the parking robot 31 received by the A35. The control device 25 transmits instructions for stopping, starting, and rerouting to the parking robot 31 as necessary. The parking robot 31 stops, starts, and reroutes in response to the instructions.

In A37, the parking robot 31 determines whether the parking robot 31 has arrived at the target parking position. When the parking robot 31 has not yet arrived at the target parking position, the present process returns to A35. When the parking robot 31 has arrived at the target parking position, the processes in A35 to A37 are finished, and the present process proceeds to A38.

In A38, the parking robot 31 notifies the control device 25 of the completion of parking.

In A39, the control device 25 notifies the individual terminal 27 of the completion of parking. The control device 25 may notify the smartphone of the completion of parking.

In A40, the individual terminal 27 notifies the user of the completion of parking. The smartphone may notify the user of the completion of parking.

In A41, the control device 25 distributes a parking lot map to the vehicle 11 and transmits an ignition-on instruction to the vehicle 11. The parking lot map is map information of the automated valet parking lot 1. The ignition-on instruction is an instruction for turning on the ignition of the vehicle 11. The vehicle 11 receives the parking lot map. The vehicle 11 turns on the ignition in response to the ignition-on instruction. The vehicle 11 estimates an own position when the ignition is turned on. The own position is the current position of the vehicle 11 estimated by the vehicle 11. A method of estimating the own position is a method of imaging a marker with the sensor 12 mounted on the vehicle 11 and estimating the own position based on a position of the marker.

In A42, the vehicle 11 transmits an ignition-on notification, the own position estimated in A41, and a width of a second allowable range 53 to the control device 25. The ignition-on notification is a notification indicating that the ignition of the vehicle 11 has already been turned on. The second allowable range 53 will be described later.

In A43, the control device 25 transmits a target parking position, a travel path, and a parking instruction to the vehicle 11. The travel path is a travel path from the current position of the vehicle 11 to the target parking position. The parking instruction is an instruction for traveling along the travel path and parking at the target parking position. The travel path is determined by the control device 25. The control device 25 may determine travel paths of multiple vehicles 11.

The processes in A44 to A46 are repeatedly performed until the vehicle 11 arrives at the target parking position. In A44, the vehicle 11 travels toward the target parking position and transmits the own position of the vehicle 11 to the control device 25. The vehicle 11 periodically and repeatedly estimates an own position while traveling along the travel path. The vehicle 11 periodically and repeatedly transmits the own position to the control device 25 while traveling along the travel path.

In A45, the control device 25 manages traffic based on the current position of the vehicle 11 received by A44. The control device 25 transmits instructions for stopping, starting, and rerouting to the vehicle 11 as necessary. The vehicle 11 stops, starts, and reroutes in response to the instructions.

In A46, the vehicle 11 determines whether the vehicle 11 has arrived at the target parking position. When the vehicle 11 has not yet arrived at the target parking position, the present process returns to A44. When the vehicle 11 has arrived at the target parking position, the processes in A44 to A46 are finished, and the present process proceeds to A47.

In A47, the vehicle 11 notifies the control device 25 of the completion of parking.

In A48, the control device 25 instructs the vehicle 11 to turn off the ignition. The vehicle 11 turns off the ignition.

In A49, the vehicle 11 notifies the control device 25 of the completion of ignition-off.

In A50, the control device 25 notifies the individual terminal 27 of the completion of parking. The control device 25 may notify the smartphone of the completion of parking.

In A51, the individual terminal 27 notifies the user of the completion of parking. The smartphone may notify the user of the completion of parking.

The above process executed by the control device 25 is executed by the parking support unit 45. The parking support unit 45 provides various instructions and information necessary for the parking robot 31 or the vehicle 11A with the AVP function to travel from the vehicle entering section 13 to a target parking position. Examples of the instructions include the above pick-up instruction, instructions for stopping, starting, and rerouting, a lift-up instruction, a parking instruction, an ignition-on instruction, and an ignition-off instruction. Examples of the information include position information of a target vehicle, a travel path, target parking position information, and a parking lot map.

4. Exiting Processing Executed by Control System 23 and Exiting Request Vehicle

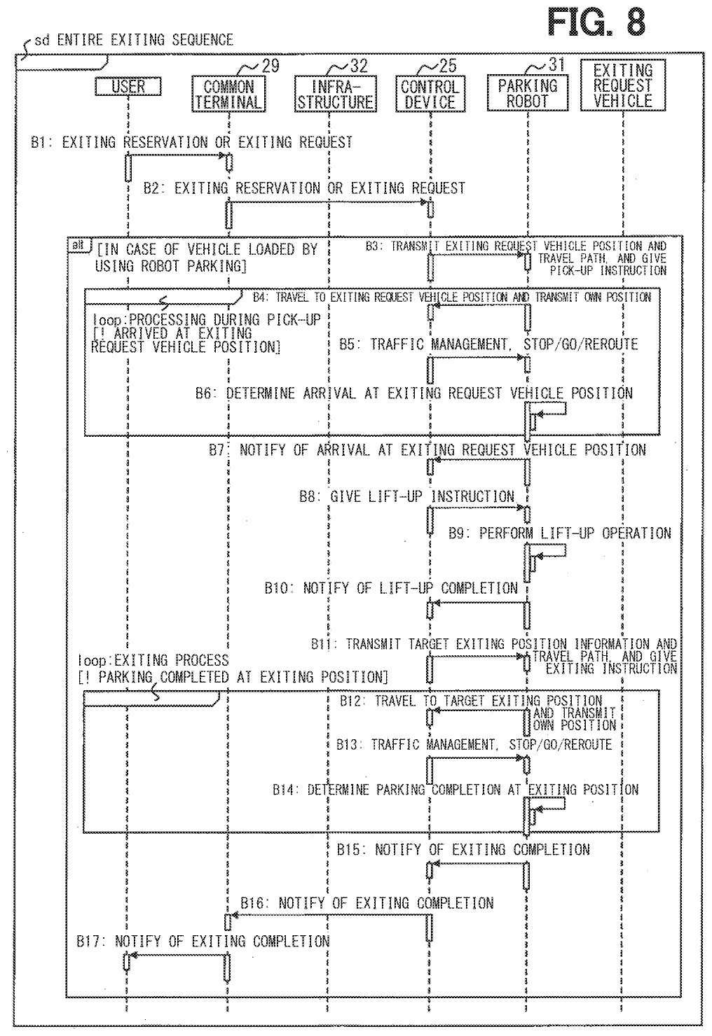

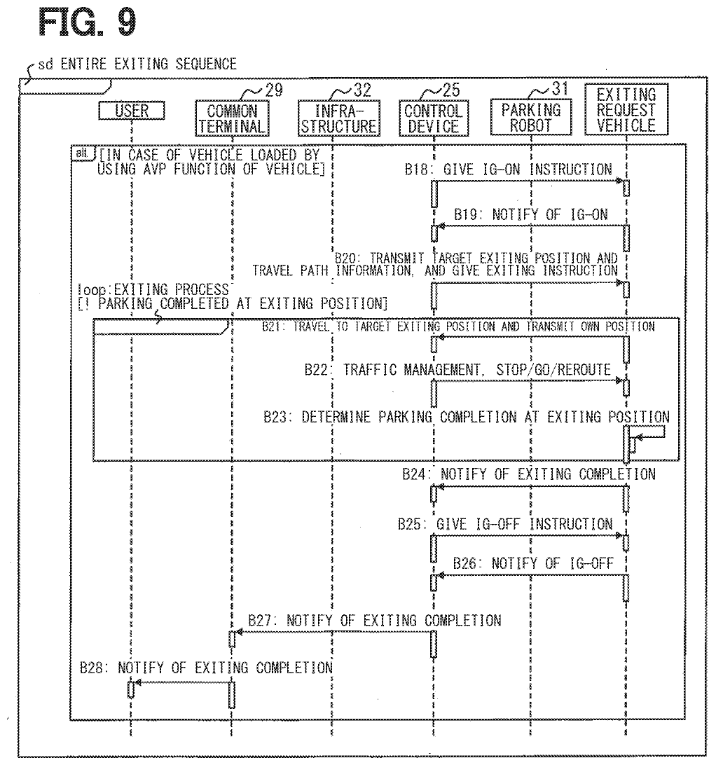

The processing related to exiting executed by the control system 23 and the exiting request vehicle will be described with reference to FIGS. 8 and 9.

In B1, the user makes an exiting reservation or an exiting request to the common terminal 29. The user inputs identification information of the user and identification information of an exiting request vehicle into the common terminal 29. The exiting request vehicle is the vehicle 11 of which exiting is requested due to an exiting request.

In B2, the common terminal 29 transmits an exiting reservation or an exiting request to the control device 25. When the common terminal 29 transmits the exiting reservation, the following processing is executed according to the reservation time of the exiting reservation. When the common terminal 29 transmits the exiting request, the following processing is immediately executed.

When the exiting request vehicle is parked by robot parking, the processes in B3 to B17 are executed. When the vehicle 11 is parked by the AVP function of the exiting request vehicle, the processes in B18 to B28 are executed.

In B3, the control device 25 transmits an exiting request vehicle position, a travel path, and a pick-up instruction to the parking robot 31. The exiting request vehicle position is the current position of the exiting request vehicle. The travel path is a travel path from the current position of the parking robot 31 to the exiting request vehicle position. The pick-up instruction is an instruction for picking up the exiting request vehicle.

The processes in B4 to B6 are repeatedly performed until the parking robot 31 arrives at the exiting request vehicle position. In B4, the parking robot 31 travels toward the exiting request vehicle position, and transmits the current position of the parking robot 31 to the control device 25.

In B5, the control device 25 manages traffic based on the current position of the parking robot 31 received in B4. The control device 25 transmits instructions for stopping, starting, and rerouting to the parking robot 31 as necessary. The parking robot 31 stops, starts, and reroutes in response to the instructions.

In B6, the parking robot 31 determines whether the parking robot 31 has arrived at the exiting request vehicle position. When the parking robot 31 has not yet arrived at the exiting request vehicle position, the present process returns to B4. When the parking robot 31 arrives at the exiting request vehicle position, the processing of B4 to B6 are finished, and the present process proceeds to B7.

In B7, the parking robot 31 notifies the control device 25 that the parking robot 31 has arrived at the exiting request vehicle position.

In B8, the control device 25 instructs the parking robot 31 to lift up the exiting request vehicle.

In B9, the parking robot 31 lifts up the exiting request vehicle. When the lift-up is completed, the present process proceeds to B10.

In B10, the parking robot 31 notifies the control device 25 of the completion of lift-up.

In B11, the control device 25 transmits target exiting position information, a travel path, and an exiting instruction to the parking robot 31. The target exiting position is one of the vehicle exiting sections 15. The target exiting position information is position information indicating the target exiting position. The travel path is a travel path from the current position of the parking robot 31 to the target exiting position. The exiting instruction is an instruction for exiting the exiting request vehicle to the target exiting position.

The processes in B12 to B14 are repeatedly performed until the parking robot 31 arrives at the target exiting position. In B12, the parking robot 31 travels toward the target exiting position and transmits the current position of the parking robot 31 to the control device 25.

In B13, the control device 25 manages traffic based on the position of the parking robot 31 received by the B12. The control device 25 transmits instructions for stopping, starting, and rerouting to the parking robot 31 as necessary. The parking robot 31 stops, starts, and reroutes in response to the instructions.

In B14, the parking robot 31 determines whether the parking robot 31 has arrived at the target exiting position. When the parking robot 31 has not yet arrived at the target exiting position, the present process returns to B12. When the parking robot 31 has arrived at the target exiting position, the processes in B12 to B14 are finished, and the present process proceeds to B15.

In B15, the parking robot 31 notifies the control device 25 of the completion of exiting.

In B16, the control device 25 notifies the common terminal 29 of the completion of exiting. The control device 25 may notify the smartphone of the completion of exiting.

In B17, the common terminal 29 notifies the user of the completion of exiting. The smartphone may notify the user of the completion of exiting.

In B18, the control device 25 transmits an ignition-on instruction to the exiting request vehicle. The exiting request vehicle turns on the ignition in response to the ignition-on instruction.

In B19, the exiting request vehicle transmits an ignition-on notification to the control device 25.

In B20, the control device 25 transmits a target exiting position, a travel path, and an exiting instruction to the exiting request vehicle. The travel path is a travel path from the current position of the exiting request vehicle to the target exiting position.

The processes in B21 to B23 are repeatedly performed until the exiting request vehicle arrives at the target exiting position. In B21, the exiting request vehicle travels toward the target exiting position, and the current position of the exiting request vehicle is transmitted to the control device 25.

In B22, the control device 25 manages traffic based on the current position of the exiting request vehicle received in B21. The control device 25 transmits instructions for stopping, starting, and rerouting to the exiting request vehicle as necessary. The exiting request vehicle stops, starts, and reroutes in response to the instructions.

In B23, the exiting request vehicle determines whether the exiting request vehicle has arrived at the target exiting position. When the exiting request vehicle has not yet arrived at the target exiting position, the present process returns to B21. When the exiting request vehicle has arrived at the target exiting position, the processes in B21 to B23 are finished, and the present process proceeds to B24.

In B24, the exiting request vehicle notifies the control device 25 of the completion of exiting.

In B25, the control device 25 instructs the exiting request vehicle to turn off the ignition. The exiting request vehicle turns off the ignition.

In B26, the exiting request vehicle notifies the control device 25 of the completion of ignition-off.

In B27, the control device 25 notifies the common terminal 29 of the completion of exiting. The control device 25 may notify the smartphone of the completion of exiting.

In B28, the common terminal 29 notifies the user of the completion of exiting.

The smartphone may notify the user of the completion of exiting.

5. Accuracy-Related Processing Executed by Control Device 25

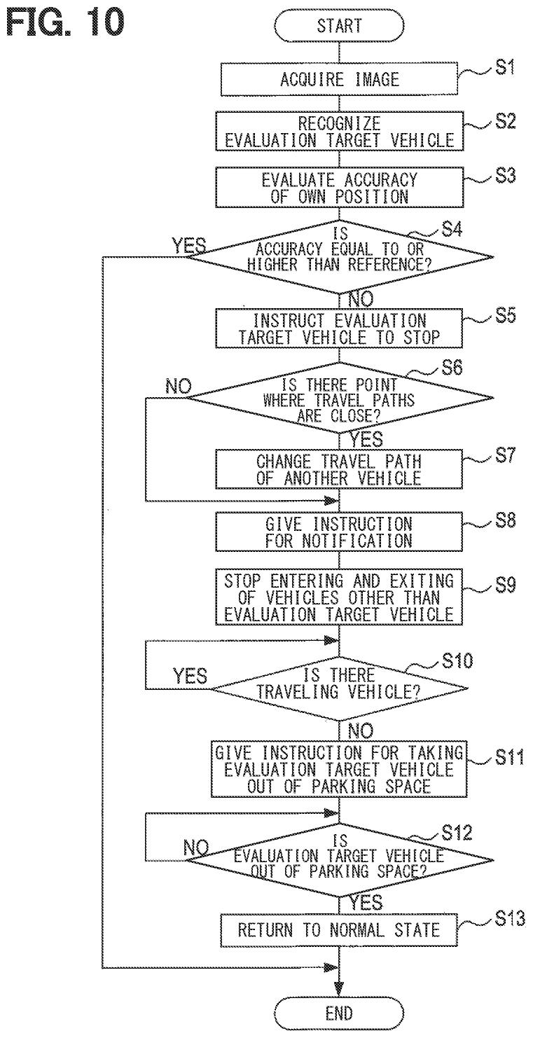

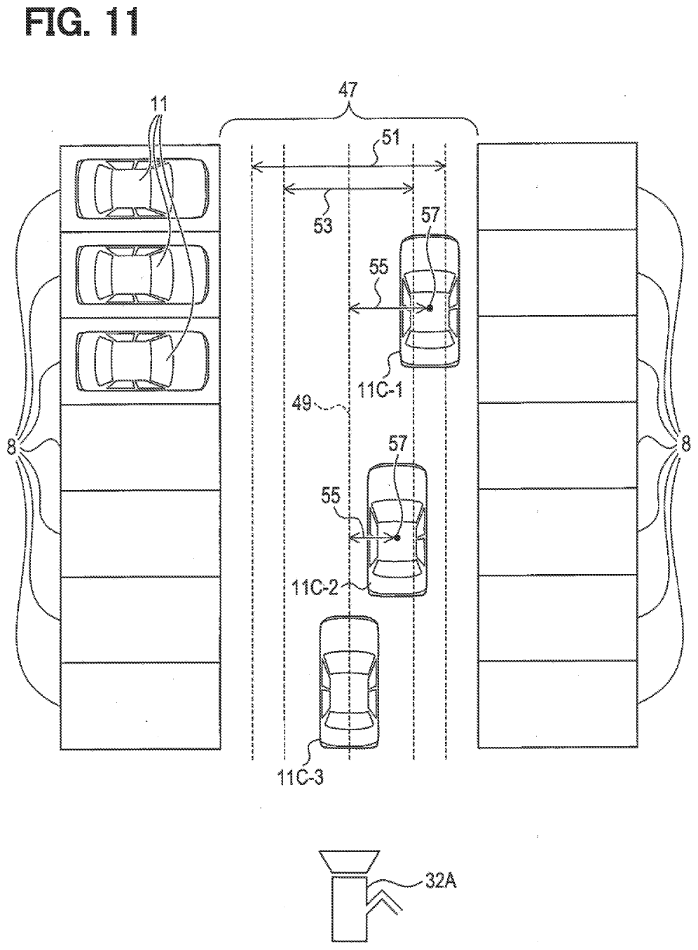

The accuracy-related processing executed by the control device 25 will be described with reference to FIGS. 10 and 11. As illustrated in FIG. 11, the control device 25 starts the accuracy-related processing when the vehicle 11A with the AVP function travels in a portion of the passage 47 imaged by a camera 32A that is a part of the infrastructure 32. The camera 32A is attached above the passage 47.

The vehicle 11A with the AVP function, which triggered the start of the accuracy-related processing, will be referred to as an evaluation target vehicle 11C below. The evaluation target vehicle 11C is traveling along a travel path 49. The travel path 49 is a travel path from the vehicle entering section 13 to the parking section 8, or a travel path from the parking section 8 to the vehicle exiting section 15.

The accuracy-related processing may be performed in a part of the region of the passage 47. For example, the control device 25 may perform the accuracy-related processing based on information from the camera 32A provided in a curved region of the passage 47. For example, the control device 25 may perform the accuracy-related processing based on information from the camera 32A provided in a region where all the vehicles 11 travel in the passage 47.

In step 1 in FIG. 10, the accuracy evaluation unit 41 images a range including the evaluation target vehicle 11C by using the camera 32A and acquires an image. The accuracy evaluation unit 41 may, for example, analyze an image captured by each camera 32A and recognize the evaluation target vehicle 11C, or may recognize the evaluation target vehicle 11C by using an image captured by the camera 32A corresponding to position information transmitted from the evaluation target vehicle 11C. The camera 32A corresponds to a sensor. An analysis result of an image from the camera 32A and a captured image corresponds to information from the sensor.

In step 2, the accuracy evaluation unit 41 recognizes the evaluation target vehicle 11C in the image acquired in step 1. The accuracy evaluation unit 41 recognizes the evaluation target vehicle 11C for example, by comparing a captured image of the same place where the evaluation target vehicle 11C is not present with the image acquired in step 1.

In the control device 25, the control unit 33 is communicatively connected to each camera 32A by wire or wirelessly. The accuracy evaluation unit 41 receives the captured image or the analysis result of the captured image from each camera 32A.

The accuracy evaluation unit 41 may receive detection data of the LIDAR instead of the image obtained by the camera 32A. In this case, the accuracy evaluation unit 41 recognizes the evaluation target vehicle 11C by using the detection data of the LIDAR.

The detection data from the LIDAR corresponds to information from a sensor. The accuracy evaluation unit 41 may receive the image obtained by the camera 32A and the detection data of the LIDAR. In this case, the accuracy evaluation unit 41 recognizes the evaluation target vehicle 11C by using a combination of the image obtained by the camera 32A and the detection data of the LIDAR. The image obtained by the camera 32A and the detection data of the LIDAR correspond to information from a sensor.

In step 3, the accuracy evaluation unit 41 evaluates the accuracy of the own position estimated by the evaluation target vehicle 11C. The accuracy evaluation unit 41 evaluates the accuracy of the own position estimated by the evaluation target vehicle 11C by determining whether the recognized position of the evaluation target vehicle 11C exceeds a preset allowable range. An evaluation method is as follows. In the image acquired in step 1, a first allowable range 51 and a second allowable range 53 illustrated in FIG. 11 are specified.

The first allowable range 51 is a range having a certain width including the travel path 49. That is, the first allowable range 51 includes the travel path 49 with a predetermined margin. The travel path 49 is located at the center of the first allowable range 51. The width of the first allowable range 51 is stored in advance by the control device 25. When the own position estimation function of the evaluation target vehicle 11C is normal, it is unlikely that the evaluation target vehicle 11C will protrude outside the first allowable range 51 regardless of the vehicle type of the evaluation target vehicle 11C. The first allowable range 51 is, for example, a range set according to a situation of the travel path 49 or the automated valet parking lot 1.

The second allowable range 53 is a range having a certain width including the travel path 49. The travel path 49 is located at the center of the second allowable range 53. The width of the second allowable range 53 is smaller than the width of the first allowable range 51. The width of the second allowable range 53 differs depending on the vehicle type of the evaluation target vehicle 11C. In A42, the control device 25 acquires and stores the width of the second allowable range 53 corresponding to the vehicle type of the evaluation target vehicle 11C from the evaluation target vehicle 11C.

The evaluation target vehicle 11C transmits the width of the second allowable range 53 to the control device 25 after communication connection with the control device 25. The second allowable range 53 is, for example, a range set according to the evaluation target vehicle 11C. The second allowable range 53 is, for example, a range different for each evaluation target vehicle 11C.

When the own position estimation function of the evaluation target vehicle 11C is normal, it is unlikely that the evaluation target vehicle 11C will protrude outside the second allowable range 53. A part of an evaluation target vehicle 11C-1 illustrated in FIG. 11 protrudes outside the first allowable range 51 and the second allowable range 53. A part of an evaluation target vehicle 11C-2 illustrated in FIG. 11 protrudes outside the second allowable range 53. However, the entire evaluation target vehicle 11C-2 is within the first allowable range 51. The entire evaluation target vehicle 11C-3 illustrated in FIG. 11 is within the second allowable range 53.

Each of the evaluation target vehicle 11C-1, the evaluation target vehicle 11C-2, and the evaluation target vehicle 11C-3 illustrated in FIG. 11 receives a travel path 49 from the control device 25. Each of the evaluation target vehicle 11C-1, the evaluation target vehicle 11C-2, and the evaluation target vehicle 11C-3 performs own position estimation and vehicle control. The vehicle control is performed such that the own position is on the travel path 49. Although the evaluation target vehicle 11C-2 and the evaluation target vehicle 11C-3 deviate from the travel path 49, the own position estimated by the evaluation target vehicle 11C is on the travel path 49.

The accuracy evaluation unit 41 determines whether each of the following conditions of J1 and J2 is established.

J1: In the image acquired in the above step 1 immediately before, at least a part of the evaluation target vehicle 11C protrudes outside the first allowable range 51.

J2: A length of time during which at least a part of the evaluation target vehicle 11C continuously or intermittently protrudes outside the second allowable range 53 in the past predetermined time exceeds a preset threshold value.

The higher the accuracy of the own position estimated by the evaluation target vehicle 11C, the more difficult it is for the conditions of J1 and J2 to be established.

In step 4, the accuracy evaluation unit 41 determines whether the accuracy of the own position estimated by the evaluation target vehicle 11C is equal to or higher than a preset reference. The fact that the accuracy of the own position is equal to or higher than the reference means that neither J1 nor J2 is established. The fact that the accuracy of the own position is lower than the reference means that J1 or J2 is established. When the accuracy of the own position is equal to or higher than the reference, the present process is finished. When the accuracy of the own position is lower than the reference, the present process proceeds to step 5.

The position of the evaluation target vehicle 11C with respect to the first allowable range 51 and the second allowable range 53 corresponds to a position of a vehicle on the travel passage in the automated valet parking lot 1. In the processes in steps 3 and 4, the position of the vehicle on the travel passage in the automated valet parking lot 1 is recognized, and the accuracy of the own position is evaluated based on the recognized position of the vehicle.

In step 5, the poor accuracy dealing unit 43 instructs the evaluation target vehicle 11C to stop. The evaluation target vehicle 11C stops in response to the instruction. A mode of stopping may be a mode of stopping immediately, a mode of gradually decelerating and stopping, or a mode of stopping after traveling to a safe place. The vehicle 11A with the AVP function includes a vehicle control unit. The vehicle control unit stops the vehicle 11A with the AVP function in response to an instruction from the poor accuracy dealing unit 43.

In step 6, the poor accuracy dealing unit 43 determines whether there is a point where a future travel path of the evaluation target vehicle 11C and a travel path of another vehicle 11A with the AVP function or the parking robot 31 are close to each other (hereinafter, referred to as a point where the travel paths are close). The future travel path of the evaluation target vehicle 11C is a portion of the travel path of the evaluation target vehicle 11C that is scheduled to travel after the present time.

Examples of points where the travel paths are cloth include a point where two travel paths are present at one location in the passage 47. At the point where the travel paths are close, the traveling directions of the two travel paths may be the same, opposite to each other, or intersect each other. When the traveling directions of the two travel paths are the same, for example, the vehicle 11 traveling on one of the two travel paths and the vehicle 11 traveling on the other travel path travel in parallel. When the traveling directions of the two travel paths are opposite to each other, for example, the vehicle 11 traveling on one of the two travel paths and the vehicle 11 traveling on the other travel path pass each other. At the point where the travel paths are close, the two travel paths may be completely coincident or may be separated by a predetermined distance.

When there is a point where the travel paths are close, the present process proceeds to step 7. When there is no point where the travel paths are close, the present process proceeds to step 8.

In step 7, the poor accuracy dealing unit 43 changes the travel path of the other vehicle 11A with the AVP function or the parking robot 31 such that there is no point where the travel paths are close. The other vehicle 11A with the AVP function or the parking robot 31 travels along the changed travel path.

In step 8, the poor accuracy dealing unit 43 instructs the evaluation target vehicle 11C, the smartphone of the user of the evaluation target vehicle 11C, or an in-vehicle notification device to notify the user. When executing the process in step 8, the smartphone is mounted in, for example, the evaluation target vehicle 11C. The mounting means that the smartphone does not necessarily have to be fixed to the evaluation target vehicle 11C. For example, placing the smartphone in a vehicle compartment of the evaluation target vehicle 11C and holding the smartphone by the user in the evaluation target vehicle 11C correspond to the mounting.

When executing the process in step 8, the smartphone may not be mounted in the evaluation target vehicle 11C, for example. That is, the poor accuracy dealing unit 43 may instruct the smartphone held by the user who has gotten off the evaluation target vehicle 11C to notify.

The evaluation target vehicle 11C or the smartphone of the user of the evaluation target vehicle 11C notifies the user in response to the instruction. The user can know from the notification that the accuracy of the own position estimated by the evaluation target vehicle 11C is low. The notification may be a voice notification or a visual notification.

In step 9, the poor accuracy dealing unit 43 stops new start of loading or exiting of the vehicle 11 other than the evaluation target vehicle 11C. By stopping new start of loading or exiting of the vehicle 11 other than the evaluation target vehicle 11C, when loading and exiting of the vehicle 11 traveling in the parking space 7 at the present time and the vehicle 11 transported by the parking robot 31 at the present time are completed, there are no vehicle 11 and parking robot 31 traveling in the parking space 7.

In step 10, the poor accuracy dealing unit 43 determines whether the vehicle 11 or the parking robot 31 traveling in the parking space 7 is present by using the infrastructure 32. When the vehicle 11 or the parking robot 31 traveling in the parking space 7 is present, the present process returns to the front of step 10. When the vehicle 11 and the parking robot 31 traveling in the parking space 7 are not present, the present process proceeds to step 11.

In step 11, the poor accuracy dealing unit 43 instructs a manager of the automated valet parking lot 1 or the user of the evaluation target vehicle 11C to take the evaluation target vehicle 11C out of the parking space 7. The manager or the user of the evaluation target vehicle 11C gets on the stopped evaluation target vehicle 11C and takes the evaluation target vehicle 11C out of the parking space 7 through manual driving, for example.

In step 12, the poor accuracy dealing unit 43 determines whether the evaluation target vehicle 11C has been taken out of the parking space 7 by using the infrastructure 32. When the evaluation target vehicle 11C has been taken out of the parking space 7, the present process proceeds to step 13. When the evaluation target vehicle 11C has not yet been taken out of the parking space 7, the present process returns to the front of step 12.

In step 13, the poor accuracy dealing unit 43 returns the state of the control device 25 to a normal state. Returning to the normal state means restarting new loading and exiting stopped in step 9.

Under the normal state, the vehicle 11 of which own position estimation accuracy is poor is not present in the parking space 7. In a state other than the normal state (hereinafter referred to as an automated valet parking stop state), the vehicle 11 of which own position estimation accuracy is poor is present in the parking space 7.

The control unit 33 manages the automated valet parking lot 1 by switching between the normal state and the automated valet parking stop state. Steps 5 to 12 in FIG. 10 correspond to the automated valet parking stop state. Step 1, step 2, step 3, step 4, and step 13 in FIG. 10 correspond to the normal state.

6. Effects of Control Device 25

(1A) The control device 25 can evaluate the accuracy of an own position estimated by the evaluation target vehicle 11C. When the accuracy of the own position estimated by the evaluation target vehicle 11C is low, the control device 25 or a user of the evaluation target vehicle 11C can take measures based on a result of the evaluation performed by the control device 25.

The control device 25 can determine travel paths of multiple vehicles 11 present in the automated valet parking lot 1.

The control device 25 recognizes a position of the vehicle 11 on the travel passage in the automated valet parking lot 1 based on information from the infrastructure 32 provided in the automated valet parking lot 1, and evaluates the accuracy of the own position based on the recognized position of the vehicle 11. Therefore, the control device 25 can evaluate the accuracy of the own position more accurately.

The control device 25 is connected to the infrastructure 32. The accuracy evaluation unit 41 acquires information from the infrastructure 32. Therefore, the control device 25 can evaluate the accuracy of the own position more accurately.

The accuracy evaluation unit 41 evaluates the accuracy of the own position by determining whether the recognized position of the vehicle 11 exceeds a preset allowable range. Therefore, the control device 25 can evaluate the accuracy of the own position more accurately.

(1B) When the accuracy of an own position estimated by the evaluation target vehicle 11C is lower than a preset reference, the control device 25 instructs the evaluation target vehicle 11C to stop. Thus, the control device 25 can restrict problems caused by the low accuracy of the own position estimated by the evaluation target vehicle 11C. The problems include, for example, the evaluation target vehicle 11C deviating from a travel path and approaching another vehicle 11 or an obstacle, and frequently causing an emergency stop.

(1C) When the accuracy of the own position estimated by the evaluation target vehicle 11C is lower than the preset reference, the control device 25 determines whether there is a point where the travel paths are close. When the control device 25 determines that there is a point where the travel paths are close, the control device 25 changes a travel path of another vehicle 11A with the AVP function or the parking robot 31 such that there is the point where the travel paths are close. Thus, the control device 25 can restrict the evaluation target vehicle 11C from being excessively close to the other vehicle 11A with the AVP function or the parking robot 31.

(1D) When the accuracy of the own position estimated by the evaluation target vehicle 11C is lower than the preset reference, the control device 25 instructs the evaluation target vehicle 11C or a smartphone of a user of the evaluation target vehicle 11C to notify the user. Therefore, the user of the evaluation target vehicle 11C can ascertain that the accuracy of the own position estimated by the evaluation target vehicle 11C is low.

### Second Embodiment

1. Differences from First Embodiment

Since a basic configuration of a second embodiment is the same as that of the first embodiment, differences will be described below. The same reference numerals as in the first embodiment denote the same elements, and reference is made to the preceding description.

In the first embodiment described above, the poor accuracy dealing unit 43 corresponds to a stop instruction unit, a proximity determination unit, a travel path change unit, and a notification unit. In contrast, in the second embodiment, the poor accuracy dealing unit 43 is different from that of the first embodiment in that the poor accuracy dealing unit 43 corresponds to a correction instruction unit, a notification unit, and a parking section change unit. Accuracy-related processing that will be described later is partially different from that of the first embodiment.

2. Accuracy-Related Processing Executed by Control Device 25

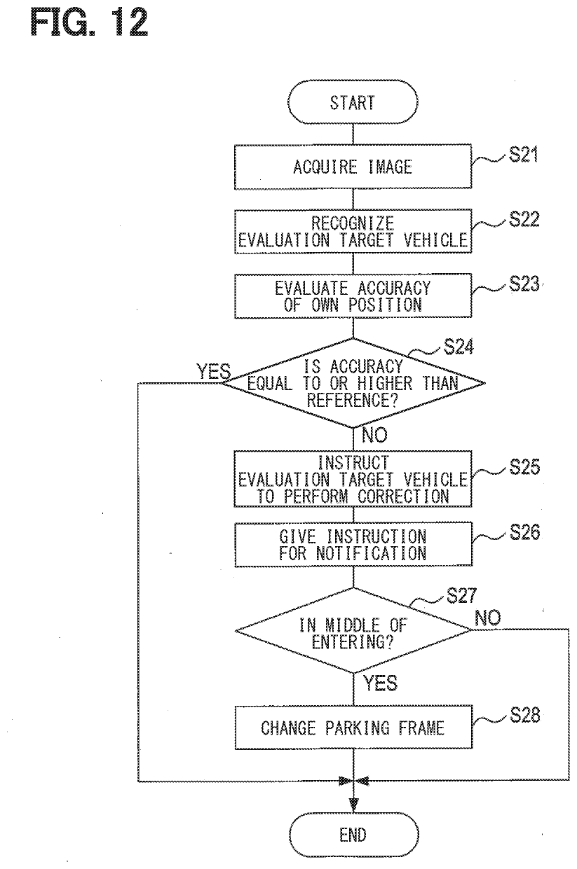

The accuracy-related processing executed by the control device 25 of the second embodiment in place of the accuracy-related processing (FIG. 10) of the first embodiment will be described with reference to flowcharts of FIGS. 11 and 12. A trigger for starting the accuracy-related processing of the second embodiment is the same as the trigger for starting the first embodiment.

The processes in steps 21 to 24 in FIG. 12 are the same as the processes in steps 1 to 4 in the accuracy-related processing of the first embodiment. When a determination is made in step 24 that the accuracy of the own position is equal to or higher than the reference, the present process is finished. When a determination is made in step 24 that the accuracy of the own position is lower than the reference, the present process proceeds to step 25.

In step 25, the poor accuracy dealing unit 43 calculates a deviation amount 55 illustrated in FIG. 11 in the image acquired in step 21. The deviation amount 55 is a distance between the center 57 of the evaluation target vehicle 11C and the travel path 49 in the direction orthogonal to the travel path 49. The deviation amount 55 is a distance between the accurate own position of the evaluation target vehicle 11C and the own position estimated by the evaluation target vehicle 11C in the direction orthogonal to the travel path 49. If the own position estimated by the evaluation target vehicle 11C is accurate, the center 57 overlaps with the travel path 49.

Next, the poor accuracy dealing unit 43 transmits information including a side on which the center 57 is located with respect to the travel path 49 and the deviation amount 55 to the evaluation target vehicle 11C. Sending this information corresponds to instructing the evaluation target vehicle 11C to correct the own position. After this time point, the evaluation target vehicle 11C corrects the estimated own position such that the deviation amount 55 becomes 0. The vehicle 11A with the AVP function is provided with a correction unit. The correction unit corrects the estimated own position according to information received from the poor accuracy dealing unit 43.

The process in step 26 is the same as the process in step 8 in the accuracy-related processing of the first embodiment.

In step 27, the poor accuracy dealing unit 43 determines whether the evaluation target vehicle 11C is in the middle of loading. When the evaluation target vehicle 11C is in the middle of loading, the evaluation target vehicle 11C travels toward the parking section 8. When a determination is made that the evaluation target vehicle 11C is in the middle of loading, the present process proceeds to step 28. When a determination is made that the evaluation target vehicle 11C is not in the middle of loading, the present process is finished.

In step 28, the poor accuracy dealing unit 43 changes the parking section 8 that is a destination of the travel path. The changed parking section 8 is, for example, a parking section 8 closer to the vehicle entering section 13 than the current parking section 8, a parking section 8 closer to the vehicle exiting section 15 than the current parking section 8, or a parking section 8 larger than the current parking section 8. In any case, the changed parking section 8 is a parking section 8 that is currently empty.

3. Advantageous Effects of Control Device 25

According to the second embodiment described in detail above, the advantageous effects (1A) and (1 D) of the above first embodiment are achieved, and the following effects are further achieved.

(2A) When the accuracy of the own position estimated by the evaluation target vehicle 11C is lower than the preset reference, the control device 25 instructs the evaluation target vehicle 11C to correct the own position. Thus, the control device 25 can improve the accuracy of the own position estimated by the evaluation target vehicle 11C. As a result, the control device 25 can restrict problems caused by the low accuracy of the own position estimated by the evaluation target vehicle 11C.

(2B) When the evaluation target vehicle 11C travels toward the parking section 8, and the accuracy of the own position estimated by the evaluation target vehicle 11C is lower than the preset reference, the control device 25 changes the parking section 8. When the changed parking section 8 is closer to the vehicle entering section 13 than the current parking section 8, a travel path to the parking section 8 can be shortened. Thus, the control device 25 can restrict problems caused by the low accuracy of the own position estimated by the evaluation target vehicle 11C.

When the changed parking section 8 is closer to the vehicle exiting section 15 than the current parking section 8, a travel path when the evaluation target vehicle 11C is unloaded can be shortened. Thus, the control device 25 can restrict problems caused by the low accuracy of the own position estimated by the evaluation target vehicle 11C.

When the changed parking section 8 is larger than the current parking section 8, the evaluation target vehicle 11C is unlikely to approach other vehicles 11 or obstacles present around the parking section 8.

### OTHER EMBODIMENTS

Although the embodiments of the present disclosure have been described above, the present disclosure is not limited to the embodiments described above, and various modifications can be made to implement the present disclosure.

(1) When the evaluation target vehicle 11C is stopped in the first embodiment, the control device 25 may use the parking robot 31 to transport the stopped evaluation target vehicle 11C out of the parking space 7. The process of transporting the evaluation target vehicle 11C by using the parking robot 31 is the same as the above B3 to B17 except that a position of the stopped evaluation target vehicle 11C is not necessarily the parking section 8.

(2) In the first and second embodiments, the control device 25 performs the accuracy-related processing on the vehicle 11A with the AVP function, and does not perform the accuracy-related processing on the parking robot 31. The control device 25 may perform the accuracy-related processing on both the vehicle 11A with the AVP function and the parking robot 31. The control device 25 does not have to perform the accuracy-related processing on the vehicle 11A with the AVP function, and may perform the accuracy-related processing on the parking robot 31. The accuracy-related processing on the parking robot 31 is the same as the accuracy-related processing on the vehicle 11A with the AVP function. When performing accuracy-related processing on the parking robot 31, the parking robot 31 is a part of the system of the present disclosure.

(3) In the first and second embodiments, as a method of determining whether the accuracy of the own position estimated by the evaluation target vehicle 11C is equal to or higher than the preset reference, other methods may be used. For example, the control device 25 may determine that the accuracy of the own position is lower than the reference when J1 is established, and may determine that the accuracy of the own position is equal to or higher than the reference when J1 is not established. The control device 25 may determine that the accuracy of the own position is lower than the reference when J2 is established, and may determine that the accuracy of the own position is equal to or higher than the reference when J2 is not established.

(4) Details of J1 and J2 may be other than those. Details of J1 and J2 may be determined as appropriate such that the lower the accuracy of the own position, the easier the details are to satisfy. The details of J1 and J2 may be determined as appropriate such that the larger the deviation amount 55, the easier the details are to satisfy.

(5) Processes executed by the control device 25 when the accuracy of the own position estimated by the evaluation target vehicle 11C is lower than the preset reference may be selected as appropriate from the processes described in the first embodiment and the second embodiment and combined. For example, the processes in steps 6 and 7 in the first embodiment may be performed in the second embodiment as well.

(6) The accuracy evaluation unit 41 may be configured to evaluate the accuracy of an own position estimated by the evaluation target vehicle 11C while the evaluation target vehicle 11C travels in the automated valet parking lot 1, based on the own position estimated by the evaluation target vehicle 11C and information from the infrastructure 32 provided in the automated valet parking lot 1. As the infrastructure 32 used for evaluating the accuracy of the own position, for example, the camera 32A may be used.

Specifically, the accuracy evaluation unit 41 specifies the current position of the evaluation target vehicle 11C by using the camera 32A. The accuracy evaluation unit 41 receives the own position transmitted by the evaluation target vehicle 11C. The accuracy evaluation unit 41 calculates a deviation amount between the current position of the evaluation target vehicle 11C specified by using the camera 32A and the own position received from the evaluation target vehicle 11C, and evaluates the accuracy of the own position based on the deviation amount.

The accuracy evaluation unit 41 evaluates that, for example, the smaller the deviation amount, the higher the accuracy of the own position. The accuracy evaluation unit 41 evaluates the accuracy of the own position by, for example, determining whether the deviation amount exceeds a preset allowable range. For example, when the deviation amount exceeds the allowable range, the accuracy evaluation unit 41 evaluates the accuracy of the own position lower than when the deviation amount does not exceed the allowable range.

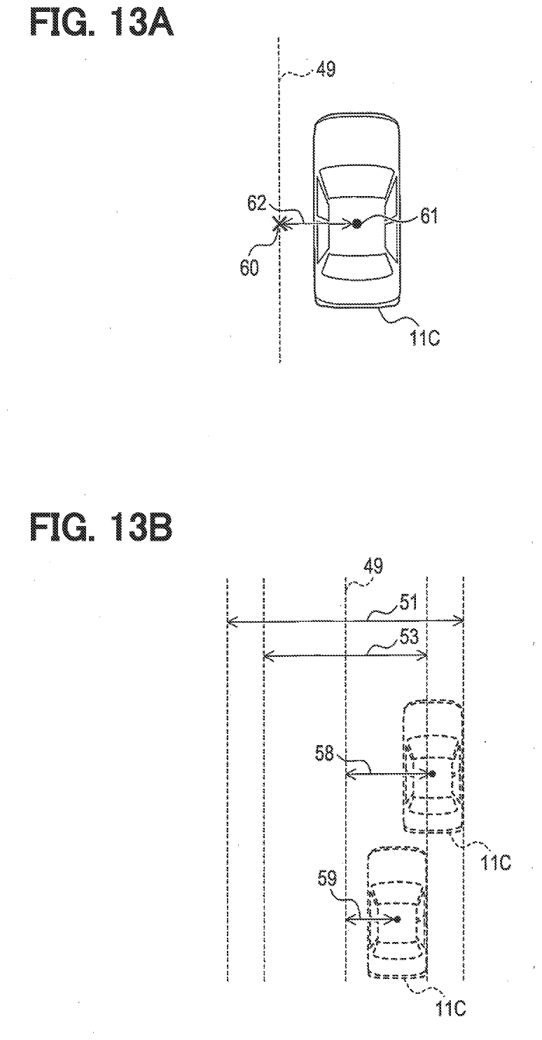

FIG. 13A schematically illustrates a deviation amount between a position of the evaluation target vehicle 11C specified by the accuracy evaluation unit 41 by using the camera 32A and an own position received from the evaluation target vehicle 11C.

The evaluation target vehicle 11C receives a travel path 49 from the control device 25. The evaluation target vehicle 11C is traveling along a travel path 49. The evaluation target vehicle 11C estimates an own position 60 illustrated in FIG. 13A and transmits the own position 60 to the control device 25. A vehicle control system included in the evaluation target vehicle 11C controls the vehicle such that the own position 60 is on the travel path 49. When the own position 60 deviates from the travel path 49, the vehicle control system guides the evaluation target vehicle 11C such that the own position 60 is on the travel path 49, for example, by adjusting steering.

The accuracy evaluation unit 41 specifies the current position 61 of the evaluation target vehicle 11C by using the camera 32A. A distance 62 of a line segment connecting the own position 60 and the current position 61 corresponds to a deviation amount between the current position 61 of the evaluation target vehicle 11C specified by using the camera 32A and the own position 60 received from the evaluation target vehicle 11C.

The accuracy evaluation unit 41 compares the calculated distance 62 with a first threshold value 58 and a second threshold value 59 illustrated in FIG. 13B. When the distance 62 exceeds the first threshold value 58, at least a part of the evaluation target vehicle 11C protrudes outside the first allowable range 51. When the distance 62 exceeds the second threshold value 59, at least a part of the evaluation target vehicle 11C protrudes outside the second allowable range 53.

FIG. 13B illustrates an example of a method of calculating the first threshold value 58 and the second threshold value 59. The first threshold value 58 corresponds to a length obtained by subtracting half of the vehicle width of the evaluation target vehicle 11C from the length of half of the first allowable range 51. The second threshold value 59 corresponds to a length obtained by subtracting the length of half of the vehicle width of the evaluation target vehicle 11C from the length of half of the second allowable range 53.

In the example illustrated in FIG. 13A, when evaluating the accuracy of the own position, only a deviation amount in the vehicle width direction is considered, but in addition to the deviation amount in the vehicle width direction, a deviation amount in the vehicle longitudinal direction may also be considered.

The first threshold value 58 may be set according to the travel path 49 or the automated valet parking lot 1. The second threshold value 59 may be set according to the evaluation target vehicle 11C. That is, the first threshold value 58 is set according to, for example, facility restrictions of the automated valet parking lot 1. The second threshold value 59 is set according to, for example, the own position estimation accuracy of the evaluation target vehicle 11C and restrictions of vehicle control.

(7) The control unit 33 and the method thereof described in the present disclosure may be realized by a dedicated computer provided by configuring a processor and a memory programmed to execute one or multiple functions embodied by a computer program. Alternatively, the control unit 33 and the method thereof described in the present disclosure may be realized by a dedicated computer provided by configuring a processor with one or more dedicated hardware logic circuits. Alternatively, the control unit 33 and the method thereof described in the present disclosure may be realized by one or more dedicated computers configured by a combination of a processor and a memory programmed to execute one or multiple functions and a processor configured by one or more hardware logic circuits. The computer program may also be stored in a computer readable non-transitory tangible recording medium as computer executable instructions. A method for realizing the functions of each unit included in the control unit 33 does not necessarily include software, and all the functions may be realized by using one or multiple pieces of hardware.

(8) Multiple functions of one element in the above embodiments may be realized by multiple elements, or one function of one element may be realized by multiple elements. Multiple functions of multiple elements may be realized by one element, or one function realized by multiple elements may be realized by one element. A part of the configuration of the above embodiment may be omitted. At least a part of the configuration of the above embodiment may be added to or substituted for the configuration of the other above embodiment.

(9) In addition to the above control device 25, the present disclosure can also be realized in various forms such as a system having the control device 25 as an element, a program for causing a computer to function as the control unit 33 of the control device 25, a non-transitory tangible recording medium such as a semiconductor memory in which this program is recorded, and an automatic parking support method.

1. A control device for an automated valet parking lot, the control device comprising:
a travel path determination unit configured to determine a travel path to one of a plurality of parking sections defined in the parking lot;
a travel path transmission unit configured to transmit the travel path to a vehicle having a function of estimating an own position and an automated valet parking function; and
an accuracy evaluation unit configured to evaluate an accuracy of the own position estimated by the vehicle when the vehicle is traveling in the automated valet parking lot, wherein
the accuracy evaluation unit is further configured to:
recognize a position of the vehicle in the automated valet parking lot based on information from a sensor disposed in the automated valet parking lot; and
evaluate the accuracy of the own position by determining whether the recognized position of the vehicle exceeds a preset allowable range that is a range including the travel path with a predetermined margin.

2. The control device according to claim 1, wherein
the vehicle are a plurality of vehicles, and
the travel path determination unit is configured to determine travel paths for the plurality of vehicles in the automated valet parking lot.

3. The control device according to claim 1, wherein
the control device is connected to the sensor, and
the accuracy evaluation unit is configured to acquire the information from the sensor.

4. The control device according to claim 1, further comprising:
a stop instruction unit that is configured to instruct the vehicle to stop when the accuracy evaluated by the accuracy evaluation unit is lower than a preset reference.

5. The control device according to claim 1, further comprising:
a correction instruction unit that is configured to instruct the vehicle to correct the own position when the accuracy evaluated by the accuracy evaluation unit is lower than a preset reference.

6. A control device for an automated valet parking lot, the control device comprising:
a travel path determination unit configured to determine a travel path to one of a plurality of parking sections defined in the parking lot;
a travel path transmission unit configured to transmit the travel path to a vehicle having a function of estimating an own position and an automated valet parking function;
an accuracy evaluation unit configured to evaluate an accuracy of the own position estimated by the vehicle when the vehicle is traveling in the automated valet parking lot;
a proximity determination unit that is configured to determine, if the accuracy of the own position evaluated by the accuracy evaluation unit is lower than a preset reference, whether there is a proximate point at which a future travel path for the vehicle and a travel path for another vehicle having the automated valet parking function are close to each other; and
a travel path change unit that is configured to change the travel path for the other vehicle having the automated valet parking function such that the proximate point does not exist.

7. The control device according to claim 1, further comprising:
a notification unit that is configured to instruct the vehicle or a terminal mounted in the vehicle to send a notification to a user when the accuracy evaluated by the accuracy evaluation unit is lower than a preset reference.

8. A control device for an automated valet parking lot, the control device comprising:
a travel path determination unit configured to determine a travel path to a targeted one of a plurality of parking sections defined in the parking lot;
a travel path transmission unit configured to transmit the travel path to a vehicle having a function of estimating an own position and an automated valet parking function;
an accuracy evaluation unit configured to evaluate an accuracy of the own position estimated by the vehicle when the vehicle is traveling in the automated valet parking lot; and
a parking section change unit that is configured to change the currently targeted parking section to (i) another parking section that is closer to a vehicle entering section or a vehicle exiting section than the currently targeted parking section or (ii) another parking section that is larger than the currently targeted parking section when the vehicle is traveling toward the currently targeted parking section and the accuracy evaluated by the accuracy evaluation unit is lower than a preset reference.

9. A system comprising:
a control device for an automated valet parking lot; and
a vehicle, wherein
the vehicle includes:
an own position estimation unit configured to estimate an own position using a first sensor mounted in the vehicle; and
an automated valet parking execution unit configured to execute automated valet parking, and
the control device includes an accuracy evaluation unit configured to evaluate an accuracy of the own position estimated by the own position estimation unit when the vehicle is traveling in the automated valet parking lot, and
the accuracy evaluation unit is further configured to:
recognize a position of the vehicle in the automated valet parking lot based on information from a second sensor disposed in the automated valet parking lot; and
evaluate the accuracy of the own position by determining whether the recognized position of the vehicle exceeds a preset allowable range that is a range including the travel path with a predetermined margin.

10. The system according to claim 9, wherein
the control device further includes a stop instruction unit that is configured to instruct the vehicle to stop when the accuracy evaluated by the accuracy evaluation unit is lower than a preset reference, and
the vehicle further includes a vehicle control unit configured to stop the vehicle in response to receiving an instruction from the stop instruction unit.

11. The system according to claim 9, wherein
the control device further includes a correction instruction unit that is configured to instruct the vehicle to correct the own position when the accuracy evaluated by the accuracy evaluation unit is lower than the preset reference, and
the vehicle further includes a correction unit configured to correct the own position estimated by the own position estimation unit in response to receiving an instruction from the correction instruction unit.

12. A control device for an automated valet parking lot, the control device comprising:
a travel path determination unit configured to determine a travel path to one of a plurality of parking sections defined in the automated valet parking lot;
a travel path transmission unit configured to transmit the travel path to a vehicle having a function of estimating an own position and an automated valet parking function; and
an accuracy evaluation unit configured to evaluate an accuracy of the own position estimated by the vehicle using the own position estimated by the vehicle and a position of the vehicle determined using information from a sensor disposed in the automated valet parking lot when the vehicle is traveling in the automated valet parking lot, wherein
the accuracy evaluation unit is further configured to:
recognize the position of the vehicle in the automated valet parking lot based on the information from the sensor disposed in the automated valet parking lot; and
evaluate the accuracy of the own position by determining whether the recognized position of the vehicle exceeds a preset allowable range that is a range including the travel path with a predetermined margin.

13. A control method for an automated valet parking lot, the control method comprising:
determining a travel path to one of a plurality of parking sections defined in the automated valet parking lot;
transmitting the travel path to a vehicle having a function of estimating an own position and an automated valet parking function; and
evaluating an accuracy of the own position estimated by the vehicle when the vehicle is traveling in the automated valet parking lot, wherein
the method further comprises:
recognizing a position of the vehicle in the automated valet parking lot based on information from a sensor disposed in the automated valet parking lot; and
evaluating the accuracy of the own position by determining whether the recognized position of the vehicle exceeds a preset allowable range that is a range including the travel path with a predetermined margin.

14. A non-transitory computer readable storage medium storing a program, the program including instructions, when executed by a computer, causing the computer to:
determine a travel path to one of a plurality of parking sections defined in the parking lot;
transmit the travel path to a vehicle having a function of estimating an own position and an automated valet parking function; and
evaluate an accuracy of the own position estimated by the vehicle when the vehicle is traveling in the automated valet parking lot, wherein
the instructions further cause the computer to:
recognize a position of the vehicle in the automated valet parking lot based on information from a sensor disposed in the automated valet parking lot; and
evaluate the accuracy of the own position by determining whether the recognized position of the vehicle exceeds a preset allowable range that is a range including the travel path with a predetermined margin.
